(19) United States
(12) Patent Application Publication
(10) Pub. No.: US 2025/0033936 A1
(43) Pub. Date: Jan. 30, 2025

(54) MOUNTING FRAMEWORK, VEHICLE CRANE AND METHOD FOR MOUNTING A BRACING APPARATUS ON A TELESCOPING JIB

(71) Applicant: Tadano Demag GmbH, Zweibrücken (DE)

(72) Inventors: Martin Bauer, Steinwenden (DE); Simon Schneider, Martinshöhe (DE); Traugott Feß, Bechhofen (DE); Andreas Lang, Langwieden (DE); Matthias Roth, Waldmohr (DE)

(21) Appl. No.: 18/783,857

(22) Filed: Jul. 25, 2024

(30) Foreign Application Priority Data
Jul. 26, 2023 (DE) 102023119815.7

(51) Int. Cl. B66C 23/36; B66C 23/78; B66C 23/82

(52) U.S. Cl. CPC B66C 23/365; B66C 23/78; B66C 23/826; B66C 2700/0357

(57) ABSTRACT

A mounting framework of a vehicle crane in which at least one bracing arm of a bracing apparatus of the vehicle crane can be temporarily stored on the mounting framework, where the mounting framework comprises at least one displaceable sliding frame and a single bracing arm can be temporarily stored on the sliding frame. In order to provide a mounting framework of a vehicle crane with an optimized placing option for a bracing apparatus on the lower carriage, the mounting framework comprises one displaceable sliding frame. A vehicle crane is configured with such a mounting framework and embodiments include a method for mounting a bracing apparatus on a telescoping jib of a vehicle crane comprising such a mounting framework.

### CROSS REFERENCE TO RELATED APPLICATION

The present application claims the priority benefits of German application no. 10 2023 119 815.7, filed on Jul. 26, 2023.

### BACKGROUND AND FIELD OF THE INVENTION

The invention relates to a mounting framework of a vehicle crane, where at least one bracing arm of a bracing apparatus of the vehicle crane can be temporarily stored on the mounting framework, the mounting framework comprises at least one displaceable sliding frame and a single bracing arm can be temporarily stored on the sliding frame. Furthermore, the invention also relates to a vehicle crane comprising such a mounting framework. The invention also relates to a method for mounting a bracing apparatus on a telescoping jib of a vehicle crane.

German patent specification DE 10 2021 111 922 B3 discloses a mounting and transport framework for two bracing arms that can be mounted onto a telescoping jib of a vehicle crane in order to increase the load-bearing capacity. The bracing arms are mounted on the same mounting and transport framework for transport on a low loader, for transport between the low loader and the vehicle crane and for preparation for mounting on the vehicle crane. The mounting and transport framework consists substantially of a base frame having a left frame part with support legs for receiving a first bracing arm and having a right frame part with support legs for receiving a second bracing arm. The right and left frame parts are arranged on the base frame so as to be displaceable relative to one another in order to move them as required between a narrow transport position to a wide mounting position and vice versa. For transport on the low loader, the mounting and transport framework is placed together with the supported first and second bracing arms on the low loader and the frame parts are located in the narrow transport position. In order to mount the first bracing arm and the second bracing arm onto the telescoping jib of the vehicle crane, the mounting and transport framework is lifted together with the two bracing arms by the telescoping crane onto a mounting surface on a lower carriage of the vehicle crane and is bolted at this location. In one variant, the two bracing arms are only then moved apart from one another from the narrow transport position to the wide mounting position. Subsequently, the telescoping jib is luffed down and is introduced between the two bracing arms, the two bracing arms are fastened individually to the telescoping jib and are then each detached from the mounting and transport framework. In a typical manner, the telescoping jib is then erected and the bracing arms are spayed and braced. During operation of the vehicle crane, the mounting and transport framework can remain on the lower carriage and, where required, can be used as a storage area for the bracing arms.

European patent specification EP 2 248 754 B1 discloses a further vehicle crane comprising bracing arms which can be mounted by the vehicle crane itself. In this case, the two bracing arms are also transported on a separate low loader to a deployment site of the vehicle crane. The bracing arms are connected at one end via a u-shaped holding frame to form a structural unit and are provided at their opposite ends in each case with foot supports which can be dismounted and can be varied in length. In order to mount the bracing arms on a telescoping jib of the vehicle crane, the structural unit is raised from the low loader by means of the telescoping jib of the vehicle crane and is placed behind a lower carriage of the vehicle crane in extension of the lower carriage. In this case, foot supports which can be varied in length rest on a ground surface and the foot supports which can be dismounted rest in the region of the U-shaped holding frame on the lower carriage. In this case also, the bracing arms are fastened to the telescoping jib via the holding frame after the telescoping jib has been introduced between the two bracing arms, and the foot supports which can be dismounted are dismounted from the holding frame. The foot supports which can be varied in length remain on the bracing arms.

Furthermore, European patent specification EP 1 342 692 B1 discloses a further vehicle crane, of which both bracing arms are again transported separately from the vehicle crane on a low loader to the deployment site. Upon arrival at the deployment site, the bracing arms are then lifted by means of the vehicle crane from the low loader and are temporarily stored on a lower carriage of the vehicle crane. For this purpose, four leg-like brackets are arranged on the lower carriage, on which brackets the two bracing arms of the bracing apparatus are placed. Subsequently, a telescoping jib of the vehicle crane is luffed down to a substantially horizontal receiving position between the two bracing arms and the bracing arms are coupled to the telescoping jib.

In addition, international laid-open document WO 2005/092775 A1 discloses a structural unit consisting of a mounting frame and two bracing arms for mounting onto a vehicle crane. This structural unit is transported on a low loader between the deployment sites of the vehicle crane, is placed or temporarily stored, during mounting or dismounting of the bracing arms on a telescoping jib of the vehicle crane in extension of the vehicle crane, via attachable and foldable legs on a base surface and, at the end of the mounting procedure, is fastened to the top of the telescoping jib at designated mounting points.

### SUMMARY OF THE INVENTION

The present invention provides an optimized mounting framework of a vehicle crane and a vehicle crane comprising a mounting framework with an optimized temporary storage option for a bracing apparatus, as well as optimized methods for mounting a bracing apparatus on a telescoping jib of a vehicle crane.

In accordance with an embodiment of the invention, in the case of a mounting framework of a vehicle crane, where at least one bracing arm of a bracing apparatus of the vehicle crane can be temporarily stored on the mounting framework, the mounting framework comprises at least one displaceable sliding frame, and a single bracing arm can be temporarily stored on the sliding frame. An optimized temporary storage option for a bracing apparatus is achieved by virtue of the fact that the mounting framework comprises precisely one displaceable sliding frame. Therefore, the mounting framework is simple and lightweight in terms of design. With regard to the present invention, the feature relating to the temporary storage of a single bracing arm is to be understood to mean that only a first bracing arm or second bracing arm can be temporarily stored at any one time. The feature that only precisely one sliding frame is present means that the first bracing arm and the second bracing arm can only be temporarily stored and displaced into the respective mounting positions one after the other in terms of time.

In an advantageous manner, provision is made that, starting from a receiving position, the sliding frame can be displaced either in a first direction or in a second direction opposite to the first direction and can be displaced back again. The displacement movements are preferably linear in each case. The simplicity is accompanied by the fact that only a single bracing arm can be temporarily stored with the aid of the mounting framework.

In structural terms, it is advantageous that the sliding frame can be displaced in a linear mounting direction and can be displaced back again and the mounting direction extends orthogonally to a longitudinal direction of the mounting framework.

In an advantageous manner, provision is made that the mounting framework comprises a base frame, an intermediate frame and the sliding frame, the intermediate frame is arranged on the base frame and the sliding frame is arranged in a displaceable manner on the intermediate frame.

In an alternative embodiment, provision is made that the intermediate frame and the sliding frame form a structural unit and together can be detached from the base frame and, after a rotation, can then be fastened to the base frame such that, starting from the preferably fully retracted receiving position, the sliding frame can be displaced only in a second direction opposite to the first direction and can be displaced back again.

In a preferred and alternative embodiment, provision is made that only one single storage location for the first bracing arm or the second bracing arm is arranged on the sliding frame.

In a preferred and alternative embodiment, provision is made that a first storage location for the first bracing arm and a second storage location for the second bracing arm are arranged on the sliding frame.

In a particular preferred embodiment, the first support elements are arranged on the sliding frame at the first storage location and second support elements are arranged on the sliding frame at the second storage location.

Furthermore, in accordance with further aspects of the invention, in the case of a vehicle crane comprising a mounting framework, an optimized temporary storage option for a bracing apparatus is achieved by virtue of the fact that the mounting framework is fastened to a lower carriage of the vehicle crane in extension of the lower carriage. Therefore, the mounting framework is held on lower carriage at the front or rear, i.e. on a front side or rear side of the lower carriage and is oriented therewith and is not supported on a surface or top side of the lower carriage. In this case, provision is made in an advantageous manner that the mounting framework is supported on a ground surface via support legs at a rear end remote from the lower carriage.

Typically, the vehicle crane comprises a lower carriage, a superstructure and a telescoping jib. The telescoping jib comprises a basic box having retractable and extendible inner boxes, wherein a bracing apparatus having a first bracing arm and a second bracing arm can be attached to the telescoping jib and, for attachment purposes, the first bracing arm and the second bracing arm can be placed on the mounting framework one after the other.

In accordance with an aspect of the invention, an optimized method for mounting a bracing apparatus on a telescoping jib of a vehicle crane together with an optimized temporary storage option for a bracing apparatus are achieved by the following steps: providing a first transport unit having a mounting framework, received thereon, in the region of the vehicle crane; raising the mounting framework from the first transport unit by means of the vehicle crane; positioning the mounting framework in extension of a lower carriage of the vehicle crane; fastening the mounting framework to the lower carriage and detaching the vehicle crane from the mounting framework; providing a second transport unit having the bracing apparatus, which is received thereon and includes a first bracing arm and a second bracing arm, in the region of the vehicle crane; raising the first bracing arm from the second transport unit by means of the vehicle crane; lowering the first bracing arm of the bracing apparatus onto a sliding frame of the mounting framework at a first storage location by means of the vehicle crane; displacing the sliding frame in a first direction from a receiving position to a laterally extended lowering position; luffing the telescoping jib down next to the first bracing arm; displacing the sliding frame in the mounting direction and in the direction opposite to the first direction from its lowering position to a central fastening position, in which a fastening frame of the telescoping jib abuts against a basic box of the telescoping jib; fastening the first bracing arm with its fastening frame to the basic box; and repeating the aforementioned steps in relation to the second bracing arm beginning with raising the first bracing arm from the second transport unit by means of the vehicle crane and in relation to a second storage location on the sliding frame and a second direction.

In accordance with a further aspect of the invention, a further optimized method for mounting a bracing apparatus on a telescoping jib of a vehicle crane together with an optimized temporary storage option for a bracing apparatus are also achieved by the following steps: providing a first transport unit having a mounting framework, received thereon, in the region of the vehicle crane; raising the mounting framework from the first transport unit by means of the vehicle crane; positioning the mounting framework in extension of a lower carriage of the vehicle crane; fastening the mounting framework to the lower carriage and detaching the vehicle crane from the mounting framework; providing a second transport unit having the bracing apparatus, which is received thereon and includes a first bracing arm and a second bracing arm, in the region of the vehicle crane; raising the first bracing arm from the second transport unit by means of the vehicle crane; lowering the first bracing arm of the bracing apparatus onto a sliding frame of the mounting framework by means of the vehicle crane; displacing the sliding frame in a first direction from a receiving position to a laterally extended lowering position; luffing the telescoping jib down next to the first bracing arm; displacing the sliding frame in the mounting direction and in the direction opposite to the first direction from its lowering position to a central fastening position, in which a fastening frame of the telescoping jib abuts against a basic box of the telescoping jib; fastening the first bracing arm with its fastening frame to the basic box; detaching the intermediate frame and the sliding frame jointly as a structural unit from the base frame, rotating the structural unit and fastening it to the base frame such that, starting from the preferably fully retracted receiving position, the sliding frame can be displaced only in a second direction opposite to the first direction and can be displaced back again; and repeating the aforementioned steps in relation to the second bracing arm beginning with raising the first bracing arm from the second transport unit by means of the vehicle crane on the sliding frame and a second direction.

With regard to the present invention, it is understood that the first bracing arm and the second bracing arm can also be transported separately on different transport units and can be picked up therefrom or can be placed thereon.

An exemplified embodiment of the invention is explained in greater detail in the description hereinafter by reference to two embodiments shown in the drawings:

### BRIEF DESCRIPTION OF THE DRAWINGS

FIG. 1 shows a schematic and perspective view of a vehicle crane system consisting of a vehicle crane and two transport units;

FIG. 2 shows a schematic and perspective view of the vehicle crane and the first transport unit shown in FIG. 1 with a raised mounting framework;

FIG. 3 shows a schematic and perspective view of the vehicle crane shown in FIG. 2 with an attached mounting framework;

FIG. 4 shows a plan view of the mounting framework on the vehicle crane shown in FIG. 3;

FIG. 5 shows a schematic and perspective view of the vehicle crane and the second transport unit shown in FIG. 1 with a raised bracing arm;

FIG. 6 shows a schematic and perspective view of the vehicle crane shown in FIG. 5 with the bracing arm on the attached mounting framework;

FIG. 7 shows a perspective detailed view of the mounting framework shown in FIG. 4 with a first bracing arm;

FIG. 8 shows a schematic and perspective side view of the vehicle crane with a lowered telescoping jib;

FIG. 9 shows an enlarged section of a plan view of the first bracing arm shown in FIG. 8;

FIG. 10 shows a further perspective detailed view of the mounting framework shown in FIG. 4 with a second bracing arm;

FIG. 11 shows a perspective detailed view of the mounting framework shown in FIG. 7 with the first bracing arm and the second bracing arm;

FIG. 12 shows a schematic and perspective view of the vehicle crane with two attached and braced bracing arms;

FIG. 13 shows a schematic and perspective view of a vehicle crane system consisting of a vehicle crane and two transport units;

FIG. 14 shows a schematic view of the vehicle crane and the first transport unit shown in FIG. 13 with a raised mounting framework;

FIG. 15 shows a schematic view of the vehicle crane shown in FIG. 14 with an attached mounting framework;

FIG. 16 shows a perspective detailed view of the mounting framework on the vehicle crane shown in FIG. 15;

FIG. 17 shows a schematic view of the vehicle crane and the second transport unit shown in FIG. 13 with a raised bracing arm;

FIG. 18 shows a schematic view of the vehicle crane shown in FIG. 17 with the bracing arm on the attached mounting framework;

FIG. 19 shows a perspective detailed view of the mounting framework shown in FIG. 16 with a first bracing arm;

FIG. 20 shows a schematic side view of the vehicle crane with a lowered telescoping jib;

FIG. 21 shows an enlarged section of a plan view of the first bracing arm shown in FIG. 20;

FIG. 22 shows a further perspective detailed view of the mounting framework shown in FIG. 16;

FIG. 23 shows a perspective detailed view of the mounting framework shown in FIG. 19 with a first bracing arm and a second bracing arm; and

FIG. 24 shows a schematic and perspective view of the vehicle crane with two attached and braced bracing arms.

### DESCRIPTION OF THE PREFERRED EMBODIMENTS

Firstly, a method for attaching a first bracing arm 9a and a second bracing arm 9b of a bracing apparatus 9 to a telescoping jib 6 of a vehicle crane 2 and secondly a mounting framework 11, used for this purpose, in a first variant are described hereinafter in greater detail.

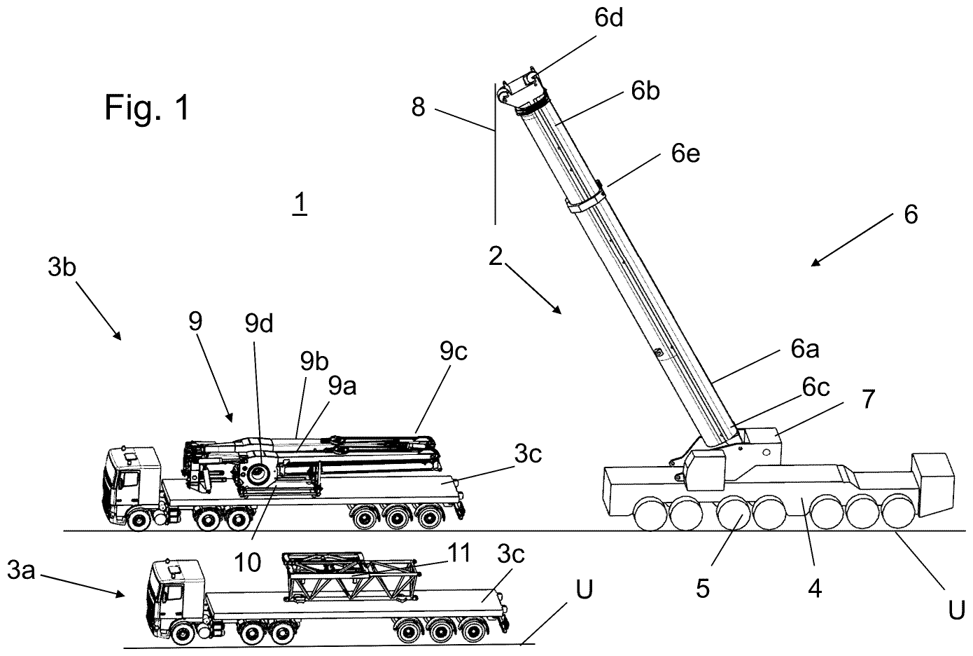

FIG. 1 shows a schematic and perspective view of a vehicle crane system 1 having a vehicle crane 2, having a first transport unit 3a and having a second transport unit 3b which are each placed on a ground surface U. The first and second transport units 3a, 3b are typically designed as trailer trucks with trailers. Such vehicle crane systems 1 are required because, by reason of the very heavy weight of the vehicle crane 2 per se, the vehicle crane 2 usually has to be driven to its respective deployment site in partially disassembled form in order to be able to comply with the maximum values specified for the public road network with regard to axle load and vehicle weight. Further attachments of the vehicle crane 2, such as e.g. a bracing apparatus 9 for increasing the load-bearing capacity of the vehicle crane 2, a telescoping jib extension, an entire telescoping jib 6 or counterweights, are thus frequently transported separately on transport units 3a, 3b.

The vehicle crane 2 which can travel on public roads typically has a multi-axle lower carriage 4 with pneumatic-tire wheels 5. Arranged on the lower carriage 4 is a superstructure 7 which carries the telescoping jib 6 and which can be pivoted relative to the lower carriage 4 about a vertical axis. The telescoping jib 6 has a basic box 6a which is articulated to the superstructure 7 so as to be able to be luffed about a horizontal axis and in the region of a telescoping jib foot 6c of the telescoping jib 6, and which receives a plurality of inner boxes 6b which can be retracted and extended linearly and of which only a first inner box 6b is shown. A lifting cable 8, from which a load-picking up means, such as e.g. a load hook with a lower block for a cable reeving arrangement, is suspended, extends over a telescoping jib head 6d which is arranged at a free end of the telescoping jib 6, in particular on an innermost one of the inner boxes 6b.

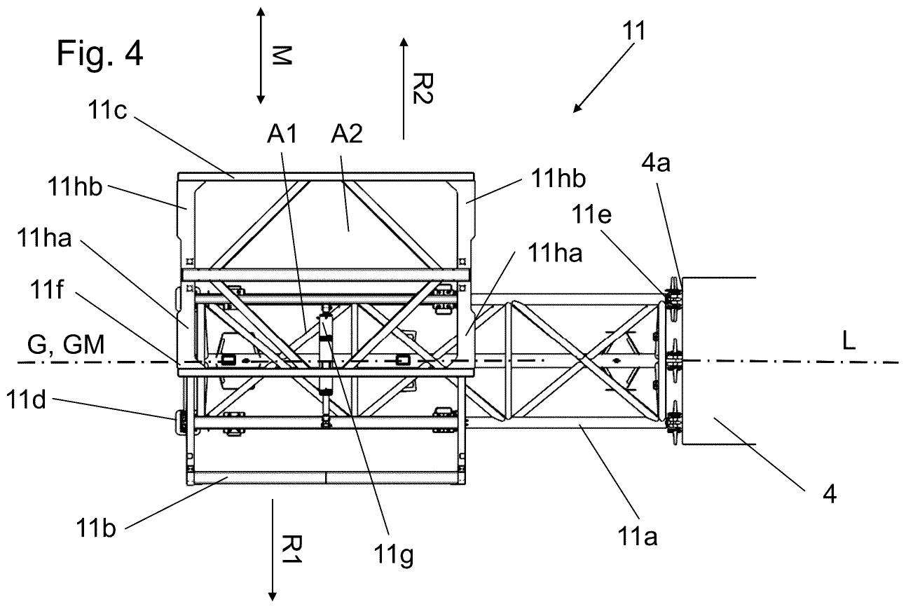

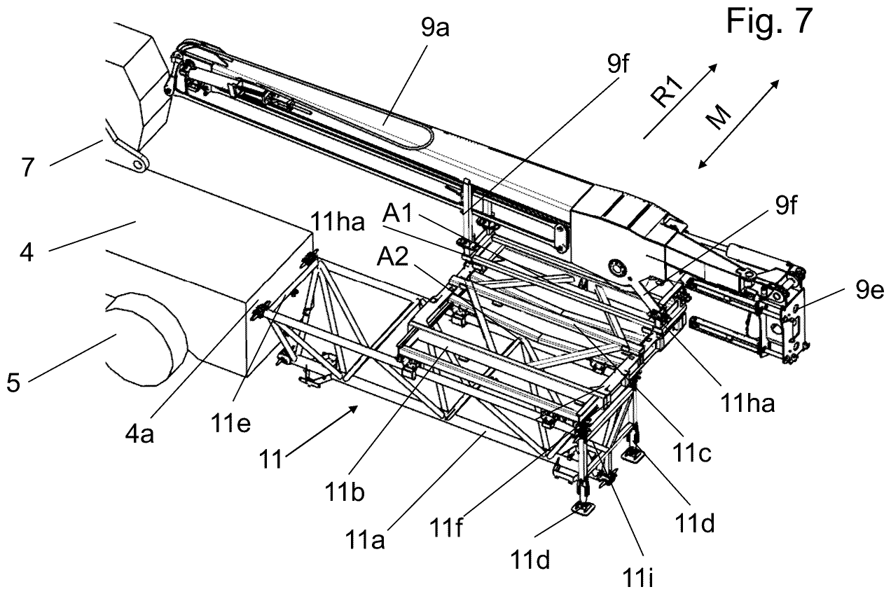

The two transport units 3a, 3b each have a loading surface 3c which is typically part of a low loader. A mounting framework 11 is transported by the first transport unit 3a. The mounting framework 11 has the function of an auxiliary framework which is used during mounting of the first and second bracing arms 9a, 9b onto the telescoping jib 6. The mounting framework 11 consists substantially of a lower base frame 11a, preferably in the form of a lattice mast portion, a central intermediate frame 11b and an upper sliding frame 11c (see FIGS. 4 and 7) and serves to extend the lower carriage 4 in order to provide a temporary storage option for the two bracing arms 9a, 9b.

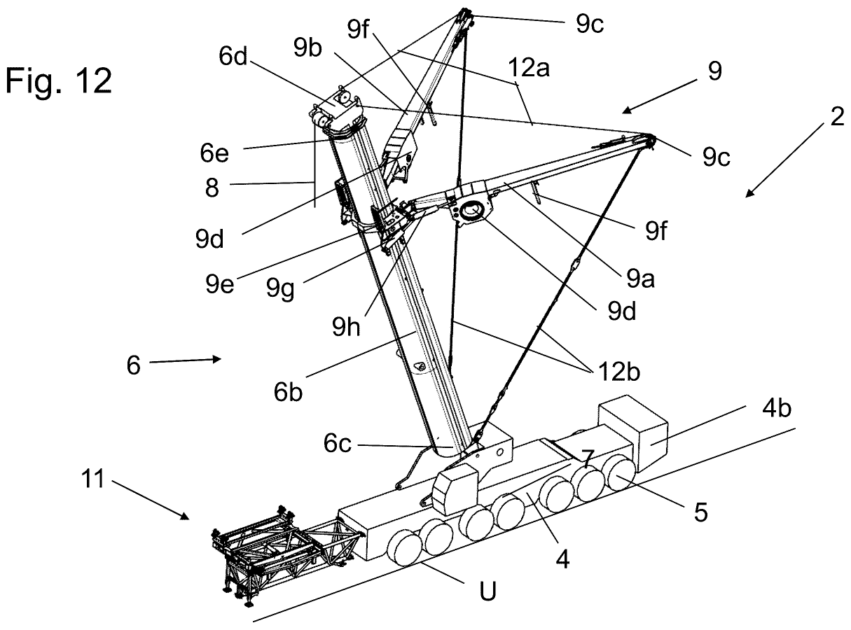

A bracing apparatus 9 for the telescoping jib 6 is transported on the loading surface 3c of the second transport unit 3b as an attachment for the vehicle crane 2. Such bracing apparatuses 9 are known for achieving an increase in the load-bearing capacity of the vehicle crane 2, provide rear and lateral bracing of the telescoping jib 6 and reduce elastic sagging of the telescoping jib 6 during operation of the vehicle crane 2. For this purpose, the bracing apparatus 9 is typically attached to the basic box 6a of the telescoping jib 6 and, in one embodiment variant, in the region of its upper collar 6e. The bracing apparatus 9 consists of a first bracing arm 9a and a second bracing arm 9b which are coupled to the telescoping jib 6 and can be splayed rearwards and in a v-shape to an operating position (see FIG. 12). It is also evident that the first and second bracing arms 9a, 9b each have, in a central and lower region, a tensioning mechanism 9d in the form of a cable winch in order to tension tensioning means, such as bracing cables 12a and bracing rods 12b (see FIG. 12) of associated bracing in an appropriate manner. On the second transport unit 3b, the two bracing arms 9a, 9b are in a horizontal, mutually parallel and spaced-apart transport position. In the transport position, the two bracing arms 9a, 9b are oriented with their longitudinal directions substantially in parallel with a longitudinal direction of the second transport unit 3b. Moreover, the two bracing arms 9a, 9b are placed as closely as possible next to one another on the loading surface 3c such that they preferably do not protrude laterally beyond the loading surface. In a mounting position of the two bracing arms 9a, 9b on the telescoping jib 6, the two bracing arms 9a, 9b are arranged next to one another, wherein the distance between the two bracing arms 9a, 9b is greater than in the transport position and is adapted to the width of the telescoping jib 6. The two bracing arms 9a, 9b are placed on the loading surface 3c in a common transport framework 10, adapted to the geometry of the two bracing arms 9a, 9b, and are secured at this location for transport purposes.

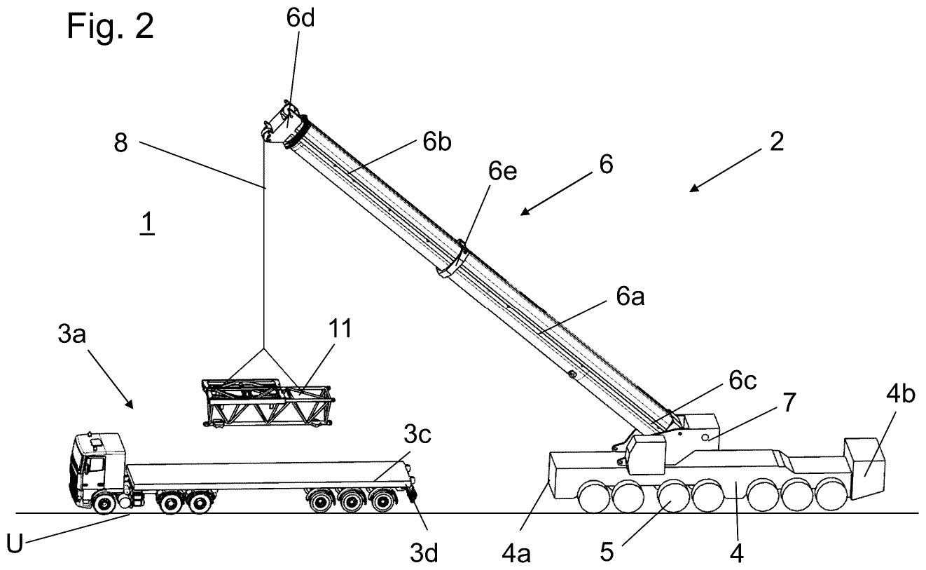

FIG. 2 illustrates a further schematic and three-dimensional view of the vehicle crane 2 and the first transport unit 3a shown in FIG. 1. At the beginning of a so-called rigging procedure for attaching the first bracing arm 9a and the second bracing arm 9b to the telescoping jib 6, the first transport unit 3a is oriented with respect to the vehicle crane 2 in such a way that the first transport unit 3a is located with its longitudinal direction in extension of the vehicle crane 2 in relation to its longitudinal direction. In this case, a distance remains between the vehicle crane 2 and the first transport unit 3a. Moreover, in this case a rear end 4a of the lower carriage 4, which is opposite to a driver's cabin 4b of the vehicle crane 2, and a rear end 3d of the second transport unit 3b face one another, so that the loading surface 3c of the first transport unit 3a faces the vehicle crane 2. Alternatively, the vehicle crane 2 can be oriented in a corresponding manner with respect to the first transport unit 3a. After orientation, the mounting framework 11 is raised from the loading surface 3c by means of the vehicle crane 2 in the next rigging step, so that the first transport unit 3a can drive away.

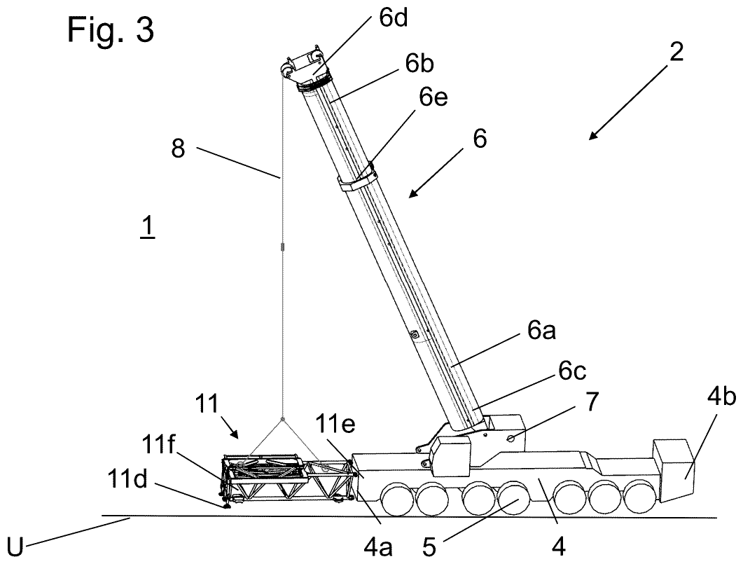

In a next step, as shown in FIG. 3 showing a schematic and perspective view of the vehicle crane 2 shown in FIG. 2 with an attached mounting framework 11, it is evident that the mounting framework 11 has been moved to a fastening position onto the rear end 4a of the lower carriage 4 by means of the vehicle crane 2. In this coupling position, the front end 11e of the mounting framework 11 abuts against the rear end 4a of the lower carriage 4. The mounting framework 11 has also been lowered so far by the vehicle crane 2 that a top side of the mounting framework 11 is approximately at a common level with a surface of the lower carriage 4, and thus a receiving surface for the two bracing arms 9a, 9b on the lower carriage 4 has been extended with the mounting framework 11. In this coupling position, the mounting framework 11 is then fastened, in particular bolted, to the lower carriage 4. Support legs 11d which can be varied in length are also arranged at the opposite, rear end 11f of the mounting framework 11 in order to support the free rear end 11f of the mounting framework 11 on the ground surface U. Subsequently, the vehicle crane 2 or its lifting cable 8 is detached from the mounting framework 11 and is available for the further mounting steps.

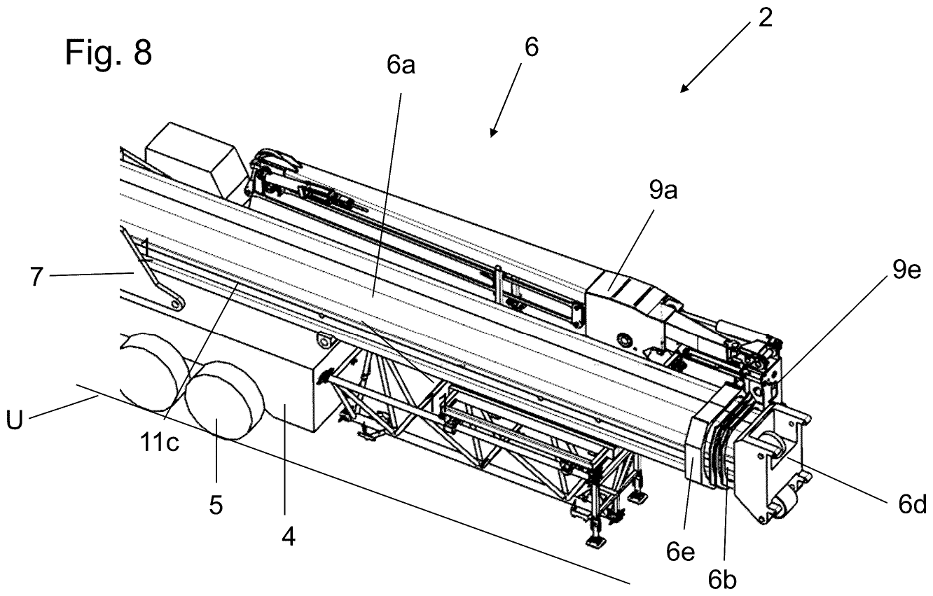

FIG. 4 shows a plan view of the mounting framework 11 shown in FIG. 3 which is already fastened to the lower carriage 4 of the vehicle crane 2. In contrast to FIG. 3, in a further rigging step the lifting cable 8 has been detached from the mounting framework 11. The structure of the mounting framework 11 will be explained in greater detail hereinafter by reference to FIG. 4. The mounting framework 11 consists substantially of a lower base frame 11a, a central intermediate frame 11b, only one upper sliding frame 11c and support legs 11d (see also FIG. 7). The base frame 11a has a lattice mast structure and can be a lattice mast portion of a telescoping jib extension having a triangular cross-section. The base frame 11a has substantially the form of a cuboid or a three-sided prism (see FIG. 7). The base frame 11a also has a longitudinal direction G which, in the coupling position of the mounting framework 11, is oriented in extension with respect to a longitudinal direction L of the lower carriage 4. The longitudinal direction G is thus indicated centrally in relation to the symmetrical base frame 11a in FIG. 4 such that it also corresponds to a center line GM of the mounting framework 11. The length of the base frame 11a is selected such that the first and second bracing arms 9a, 9b can be placed on the mounting framework 11 one after the other in terms of time such that the vehicle crane 2 with its lowered telescoping jib 6, in particular with its basic box 6a, can move next to the bracing arms 9a, 9b which are to be picked up in each case (see FIG. 8). An intermediate frame 11b is fastened, preferably clamped or screwed, to the base frame 11a in detachable manner and, after fastening, is fastened thereto in a positionally fixed manner, said intermediate frame carrying a sliding frame 11c with two first support elements 11ha, which are spaced apart from one another in the longitudinal direction G, for the first bracing arm 9a and with two further second support elements 11hb, which are spaced apart from one another in the longitudinal direction G, for the second bracing arm 9b. As seen in the longitudinal direction G, the first support elements 11ha and the second support elements 11hb are spaced apart from one another laterally in a mounting direction M. Therefore, the sliding frame 11c is designed as a double frame having a first storage location A1 for the first bracing arm 9a and a second storage location A2 for the second bracing arm 9b. The intermediate frame 11b and the sliding frame 11c are a structural unit which can be fastened to respectively suitable base frames 11a. The leg-like support elements 11ha, 11hb (see FIG. 7) are in each case spaced apart from one other in the longitudinal direction G and are designed such that either the first bracing arm 9a or the second bracing arm 9b can be securely placed thereon. The sliding frame 11c can be displaced horizontally, linearly, in a mounting direction M and relative to the intermediate frame 11b. Starting from the center line GM, the sliding arm 11c can be displaced either to the right in a first direction R1 or to the left in a second direction R2. Therefore, by means of the sliding frame 11c a bracing arm 9a, 9b received thereby can be oriented or spaced apart in a lateral manner with respect to the receiving telescoping jib 6. In relation to the intermediate frame 11b, the sliding frame 11c can be moved from a retracted receiving position to a laterally, preferably completely extended lowering position and a central fastening position. In the retracted receiving position, the symmetrical sliding frame 11c is oriented centrally with respect to the base frame 11a or intermediate frame 11b. In this case, the right first support elements 11ha are thus located slightly offset to the right in relation to the centre line GM. The second support elements 11hb are accordingly offset to the left. Fundamentally, it is also feasible that, in the receiving position, the respective first or second support elements 11ha, 11hb are oriented centrally with respect to the centre line GM. For the purpose of the displacement movement of the sliding frame 11c along the intermediate frame 11b, a hydraulic cylinder 11g is arranged between the base frame 11a and the sliding frame 11c. It is obvious that the hydraulic cylinder 11g can be replaced by any other suitable drive. In order to ensure that, starting from the central [lacuna], the first or second bracing arm 9a, 9b can be displaced sufficiently far to the right or to the left in the first or second direction R1, R2 and the intermediate frame 11b and the sliding frame 11c can be designed in a simple manner, in the case of a sliding frame 11c in a central receiving position the first support elements 11ha are arranged to the right of the centre line GM and thus already offset in the direction R1 and the second support elements 11hb are arranged to the left of the centre line GM and thus already offset in the direction R2. Starting from the receiving position, the sliding frame 11c can be displaced to the left or to the right in relation to the base frame 11a and as seen in the direction of the vehicle crane 2. This means that either only the right, first bracing arm 9a or only the left, second bracing arm 9b can be moved consecutively by the sliding frame 11c to the lowering and fastening positions required for mounting on the right side or the left side of the basic box 6a. In the inner receiving position, one of the two bracing arms 9a, 9b, in the present case the right and first bracing arm 9a, is placed onto the mounting framework 11 by the vehicle crane 2. The sliding frame 11c is shown in FIG. 4 in the left lowering position, which is displaced in the second direction R2, for the purpose of mounting the second bracing arm 9b. The sliding frame 11c is arranged in the central receiving position for the next mounting step of receiving the first bracing arm 9a. In the lowering position, the first or second bracing arm 9a, 9b to be mounted is moved laterally outwards or to the right on the outside or to the left on the outside to such an extent that the telescoping jib 6 can be lowered next to or at the height of the bracing arm 9a, 9b without colliding with the respective bracing arm 9a, 9b. From the lowering position, the bracing arm 9a, 9b can then be displaced in the direction of the telescoping jib 6 to the fastening position, so that the bracing arm 9a, 9b abuts against the basic box 6a and can be fastened at that location.

In addition, a pair of support legs 11d which can be varied in length in a vertical direction are arranged at the rear end 11f (see FIG. 7). The two support legs 11d are opposite one another and spaced apart from one another in relation to the longitudinal direction G. The two support legs 11d together with an allocated holding frame 11i also form a structural unit which can be fastened to respectively suitable base frames 11a. The support legs 11d can also be an integral part of the mounting framework 11.

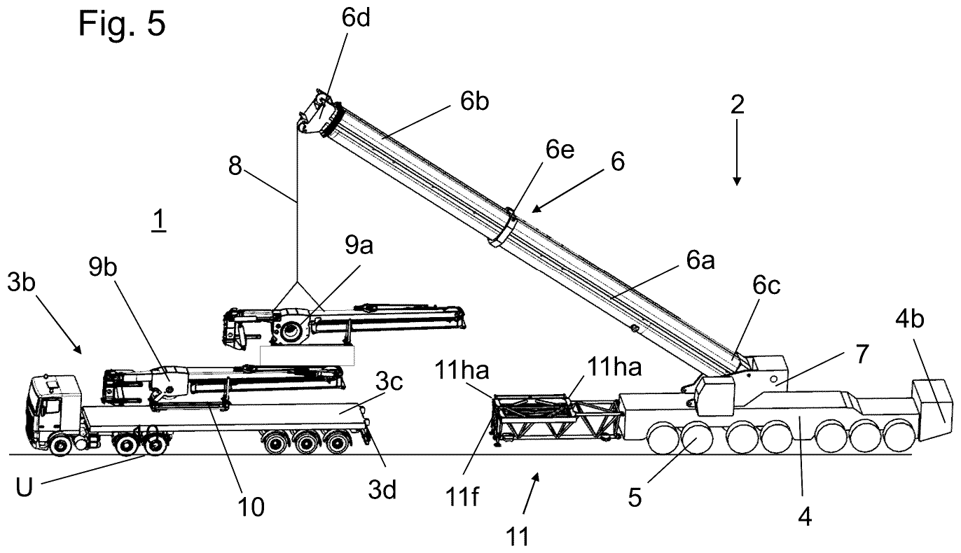

After the mounting framework 11 has been fastened to the lower carriage 4, one of the two bracing arms 9a, 9b is transported thereto in a next rigging step. For this purpose, it is apparent from FIG. 5, which shows a schematic and perspective view of the vehicle crane 2 and the second transport unit 3b shown in FIG. 1 with a raised first bracing arm 9a, that the second transport unit 3b is initially oriented with respect to the vehicle crane 2 in such a way that the second transport unit 3b is positioned with its longitudinal direction in extension of the vehicle crane 2 in relation to its longitudinal direction. As described above in respect of FIG. 2, in this case a distance remains between the vehicle crane 2 and the second transport unit 3b. Moreover, the rear end 11f of the mounting framework 11 and the rear end 3d of the second transport unit 3b face one another such that the loading surface 3c of the second transport unit 3b faces the vehicle crane 2. Alternatively, the vehicle crane 2 can be oriented in a corresponding manner with respect to the second transport unit 3b. After the orientation, in a next rigging step only the first bracing arm 9a of the two bracing arms 9a, 9b is raised from the second transport unit 3b by means of the vehicle crane 2. The first bracing arm 9a is raised in a typical manner by winding up the lifting cable 8, by luffing up the telescoping jib 6 or extending an inner box 6b, as well as combinations thereof. Prior to the raising, the lifting cable 8 has typically been connected to the first bracing arm 9a. In this case, the transport framework 10 remains on the loading surface 3c of the first transport surface 3a in precisely the same way as the second bracing arm 9b. Subsequently, the second bracing arm 9b is mounted in a comparable manner after the first bracing arm 9a has been fastened to the telescoping jib 6.

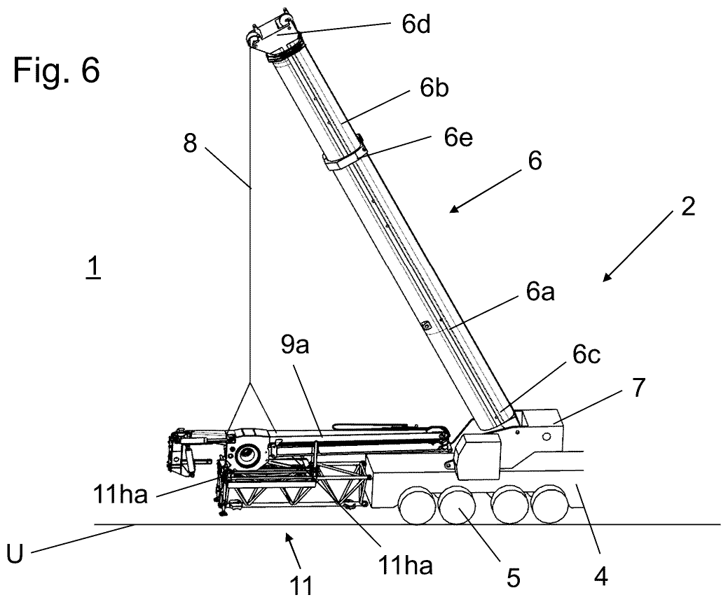

FIG. 6 shows a schematic and perspective view of the vehicle crane 2 shown in FIG. 5 in a subsequent rigging state. It is evident that the first bracing arm 9a previously received has been placed onto the mounting framework 11, in particular onto the two first support elements 11ha present at that location. The lifting cable 8 has then been detached from the first bracing arm 9a. In the present case, legs 9f are provided on the first bracing arm 9a (see FIG. 7) in order to facilitate or permit placement on the mounting framework 11. The first bracing arm 9a is thus supported on the first support elements 11ha via the legs 9f. Fundamentally, it is feasible that no legs and only reinforcements or guide surfaces are provided on the bracing arms 9a, 9b, and they cooperate directly with the support elements 11ha when being placed into position. The vehicle crane 2 is now available for the further mounting step, in particular the fastening of the first bracing arm 9a to the basic box.

FIG. 7 illustrates a perspective detailed view of the mounting framework 11 with a received first bracing arm 9a. The first bracing arm 9a has already been moved from its inner/central receiving position, in which the sliding frame 11c is located above the base frame 11a, in the first direction R1 and to its right lowering position which is extended preferably completely along the intermediate frame 11b. If the first bracing arm 9a is located in this lateral lowering position, the telescoping jib 6 can be lowered to its substantially horizontal receiving position such that the basic box 6a is oriented on a level with a fastening frame 9e of the first bracing arm 9a. The first bracing arm 9a in the lowering position does not hinder the basic box 6a from being lowered to its receiving position. There is sufficient free space, at least 100 mm and at most 1000 mm, preferably 400 mm to 800 mm, available between the basic box 6a and the first bracing arm 9a for lowering purposes.

FIG. 8 shows a schematic and perspective side view of the vehicle crane 2 with its telescoping jib 6 lowered to the horizontal receiving position. It is evident that the first bracing arm 9a extends substantially in parallel with the telescoping jib 6 and the fastening frame 9e is arranged, as seen in the side view, in front of the collar 6e of the basic box 6a. FIG. 8 and also FIG. 7 show also that the inner boxes 6b have been retracted for the purpose of lowering the telescoping jib 6. The first bracing arm 9a is still located in the lowering position, i.e. there is still a gap located between the first bracing arm 9a and the telescoping jib 6 and the first bracing arm 9a is not yet fastened to the telescoping jib 6.

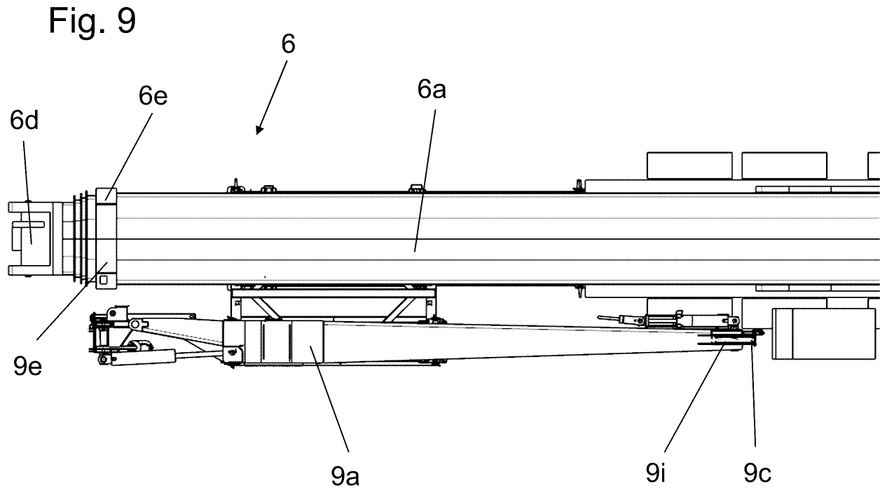

In FIG. 9 which shows an enlarged section of a plan view of the first bracing arm 9a and the telescoping jib 6 shown in FIG. 8, the first bracing arm 9a lies with its fastening frame 9e laterally adjacent and at a spaced interval with respect to the collar 6e of the basic box 6a of the telescoping jib 6. The sliding frame 11c is now displaced from its lowering position together with the first bracing arm 9a inwards onto the basic box 6a and so the fastening frame 9e comes to abut against the collar 6e of the basic box 6a. The sliding frame 11c is then located with the first bracing arm 9a in the central fastening position. Subsequently, the first bracing arm 9a is fastened, in particular bolted, to the basic box 6a. The first bracing arm 9a is then picked up from the mounting framework 11 by luffing up the telescoping jib 6 and the vehicle crane 2 is ready for mounting of the second bracing arm 9b. The first bracing arm 9a remains in an applied attachment position which extends substantially in parallel with the telescoping jib 6.

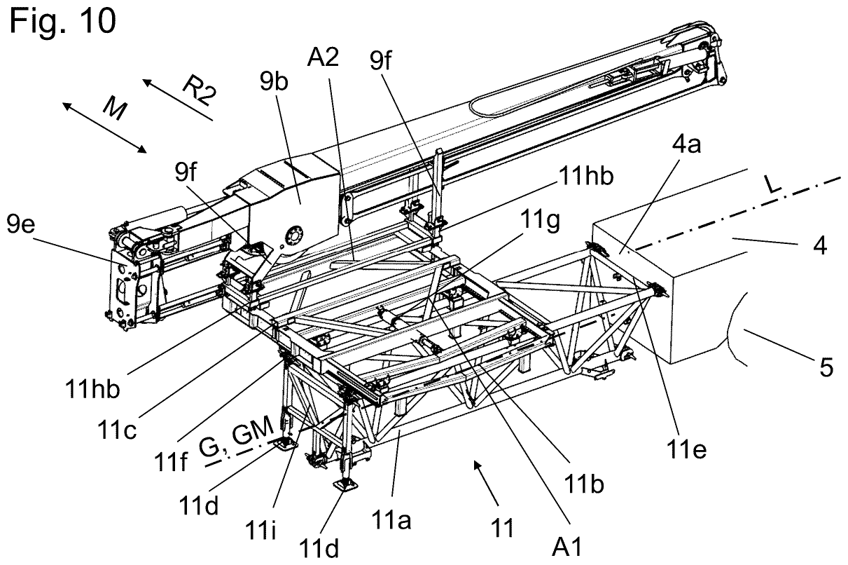

FIG. 10 shows a further perspective detailed view of the mounting framework 11 on the vehicle crane shown in FIG. 4. However, in comparison with the view in FIG. 7, the sliding frame 11c with the second bracing arm 9b has been displaced, after receiving the second bracing arm 9b in its receiving position, from its receiving position above the base frame 11a to the left to its laterally extended lowering position. The second bracing arm 9b is additionally attached to the telescoping jib next to the first bracing arm 9a, as previously described in detail in relation to the first bracing arm 9a in connection with FIGS. 5 to 9.

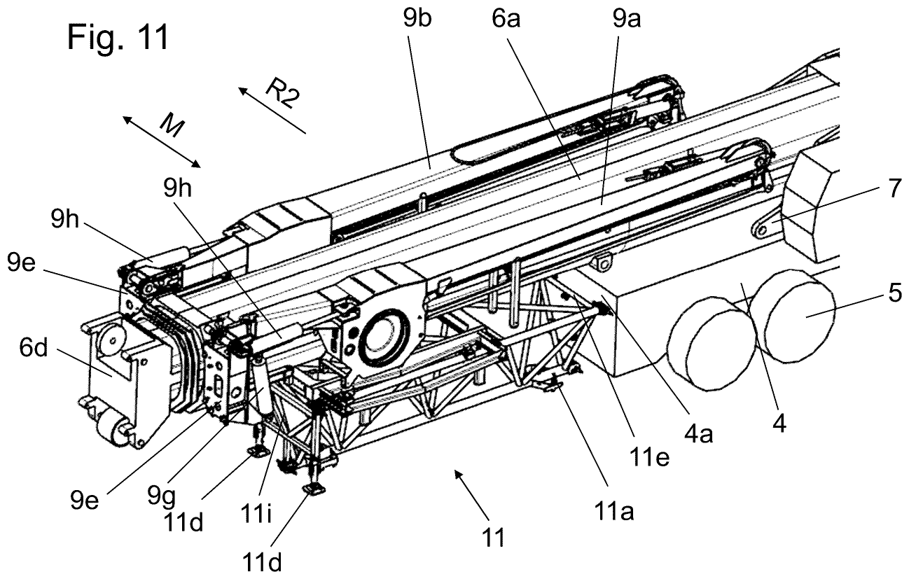

FIG. 11 shows a perspective detailed view of the mounting framework 11 with the first bracing arm 9a and the second bracing arm 9b shown in FIG. 7. The first bracing arm 9a has already been fastened to the basic box 6a, as described previously. The second bracing arm 9b has also been placed previously on the second support elements 11hb (see FIG. 10) by the vehicle crane 2. In this case, the sliding frame 11c was in its retracted receiving position. Subsequently, the sliding frame 11c has been extended to the left in the direction R2 together with the second bracing arm 9b to its left lowering position. Then, the telescoping jib 6 together with the already mounted first bracing arm 9a is luffed down to its substantially horizontal receiving position next to the second bracing arm 9b. In a further step, the sliding frame 11c is moved with the second bracing arm 9b from its lowering position inwards to its central fastening position, in which the fastening frame 9e of the second bracing arm 9b abuts against the collar 6e of the basic box 6a. Subsequently, the fastening frame 9e of the second bracing arm 9b is fastened, in particular bolted, to the collar 6e of the basic box 6a. This means that the first bracing arm 9a and the second bracing arm 9b have now been fastened to the basic box 6a one after the other in terms of time.

FIG. 12 shows a schematic and perspective view of the vehicle crane 2 with its bracing apparatus 9 with the two attached bracing arms 9a, 9b in the operating state. After the two bracing arms 9a, 9b have been attached to the telescoping jib 6 as described above, the bracing arms 9a, 9b are erected and braced in a known manner. For this purpose, in a first step, bracing cables 12a are each guided from the tensioning mechanism 9d via a deflection roller 9i arranged on a tip 9c of the respective bracing arm 9a, 9b (see FIG. 9) to the telescoping jib head 6d where they are fastened. Then, in a further step a plurality of bracing rods 12b arranged one behind the other are arranged between the telescoping jib foot 6c and the tip 9c of the respective bracing arm 9a, 9b. Instead of bracing rods 12, cables or chains or combinations thereof can also be used. The tensioning mechanism 9d is arranged below each of the bracing arms 9a, 9b and, starting from the center of the longitudinal extension of the bracing arms 9a, 9b, in a manner offset in the direction of the fastening frame 9e. As previously described, the fastening frame 9e serves to fasten the bracing arm 9a, 9b to the basic box 6a. The fastening frame 9e also comprises a double joint in order to erect the respective bracing arm 9a, 9b relative to the basic box 6a by means of an erecting cylinder 9g, arranged between the fastening frame 9e and the bracing arm 9a, 9b, and in order to be able to pivot said bracing arm laterally to the V-position by means of a pivoting cylinder 9h arranged between the fastening frame 9e and the bracing arm 9a, 9b. Subsequently, the telescoping jib 6 is luffed up together with the two bracing arms 9a, 9b. The two bracing arms 9a, 9b are then set up from their transport position almost in parallel with the telescoping jib 6 by means of the erecting cylinders 9g relative to the telescoping jib 6 and the two bracing arms 9a, 9b are splayed in a v-shape by means of the pivoting cylinders 9h. The two bracing arms 9a, 9b are thus oriented approximately orthogonally to the basic box 6a and form an angle of about 60 degrees with respect to one another. The bracing rods 12b are tensioned by the actions of erecting and pivoting-out. The bracing cables 12 are tensioned in parallel via the tensioning mechanisms 9d. Where required, the inner boxes 6b can be extended and the bracing cables 12a can be adjusted and tensioned via the tensioning mechanisms 9d. The bracing cables 12a or bracing rods 12b can also be connected to an additional counterweight. Such bracing apparatuses 9 can also be referred to as a Sideways Superlift SSL.

In a step concluding the rigging procedure, the lifting cable 8 is then attached to the mounting framework 11, the mounting framework 11 is detached from the lower carriage 4 and temporarily stored by the vehicle crane 2 at a suitable location or on the second transport unit 3b for subsequent dismounting of the two bracing arms 9a, 9b.

The bracing apparatus 9 is dismounted from the telescoping jib 6 in the reverse sequence.

Firstly, a method for attaching a first bracing arm 9a and a second bracing arm 9b of a bracing apparatus 9 to a telescoping jib 6 of a vehicle crane 2 and secondly a mounting framework 11, used for this purpose, in a second variant are described in greater detail hereinafter.

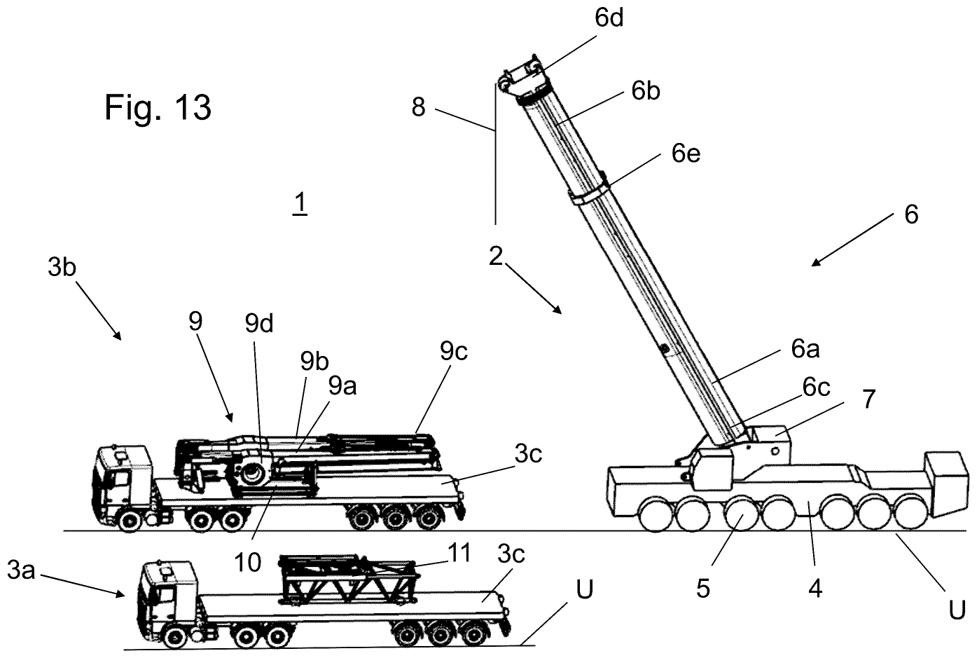

FIG. 13 shows a schematic and perspective view of a vehicle crane system 1 having a vehicle crane 2, having a first transport unit 3a and having a second transport unit 3b which are each placed on a ground surface U. The first and second transport units 3a, 3b are typically designed as trailer trucks with trailers. Such vehicle crane systems 1 are required because, by reason of the very heavy weight of the vehicle crane 2 per se, the vehicle crane 2 usually has to be driven to its respective deployment site partially disassembled in order to be able to comply with the maximum values specified for the public road network with regard to axle load and vehicle weight. Further attachments of the vehicle crane 2, such as e.g. a bracing apparatus 9 for increasing the load-bearing capacity of the vehicle crane 2, a telescoping jib extension, an entire telescoping jib 6 or counterweights, are thus frequently transported separately on transport units 3a, 3b.

The vehicle crane 2 which can travel on public roads typically has a multi-axle lower carriage 4 with pneumatic-tyred wheels 5. Arranged on the lower carriage 4 is a superstructure 7 which carries the telescoping jib 6 and which can be pivoted relative to the lower carriage 4 about a vertical axis. The telescoping jib 6 has a basic box 6a which is articulated to the superstructure 7 so as to be able to be luffed about a horizontal axis and in the region of a telescoping jib foot 6c of the telescoping jib 6, and which receives a plurality of inner boxes 6b which can be retracted and extended linearly and of which only a first inner box 6b is shown. A lifting cable 8, from which a load-picking up means, such as e.g. a load hook with a lower block for a cable reeving arrangement, is suspended, extends over a telescoping jib head 6d which is arranged at a free end of the telescoping jib 6, in particular on an innermost one of the inner boxes 6b.

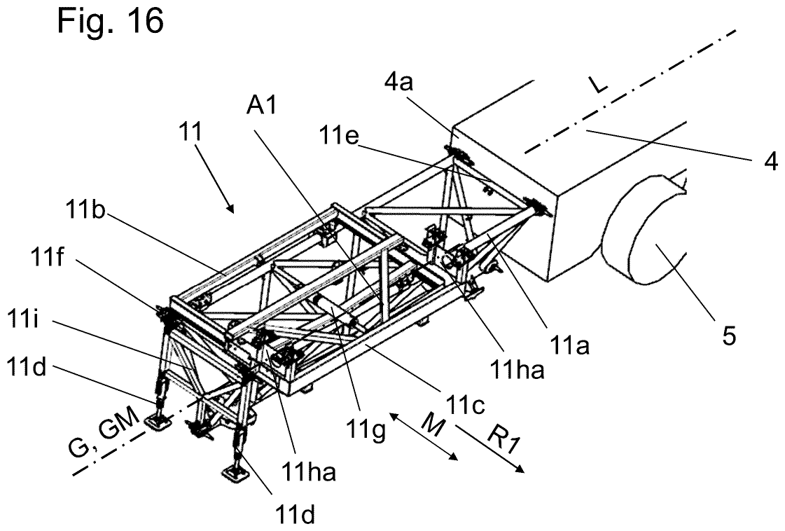

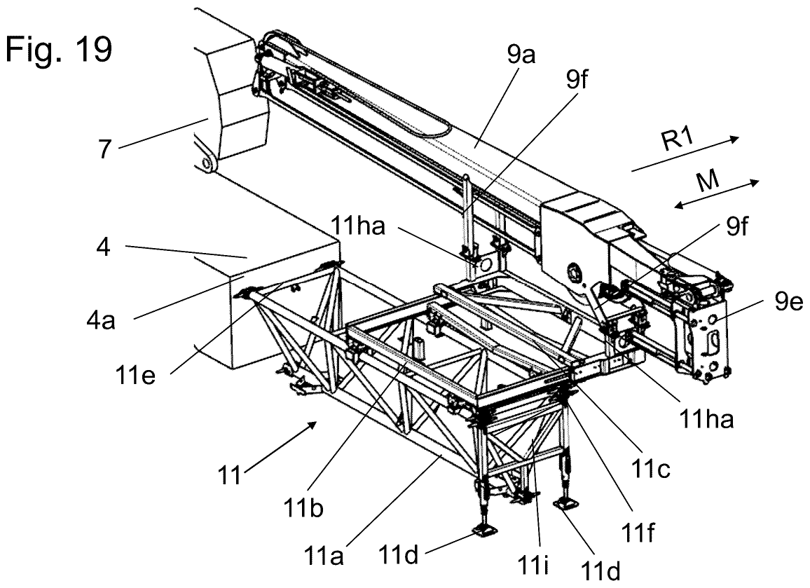

The two transport units 3a, 3b each have a loading surface 3c which is typically part of a low loader. A mounting framework 11 is transported by the first transport unit 3a. The mounting framework 11 has the function of an auxiliary framework which is used during mounting of the first and second bracing arms 9a, 9b onto the telescoping jib 6. The mounting framework 11 consists substantially of a lower base frame 11a, preferably in the form of a lattice mast portion, a central intermediate frame 11b and an upper sliding frame 11c (see FIGS. 16 and 19) and serves to extend the lower carriage 4 in order to provide a temporary storage option for the two bracing arms 9a, 9b.

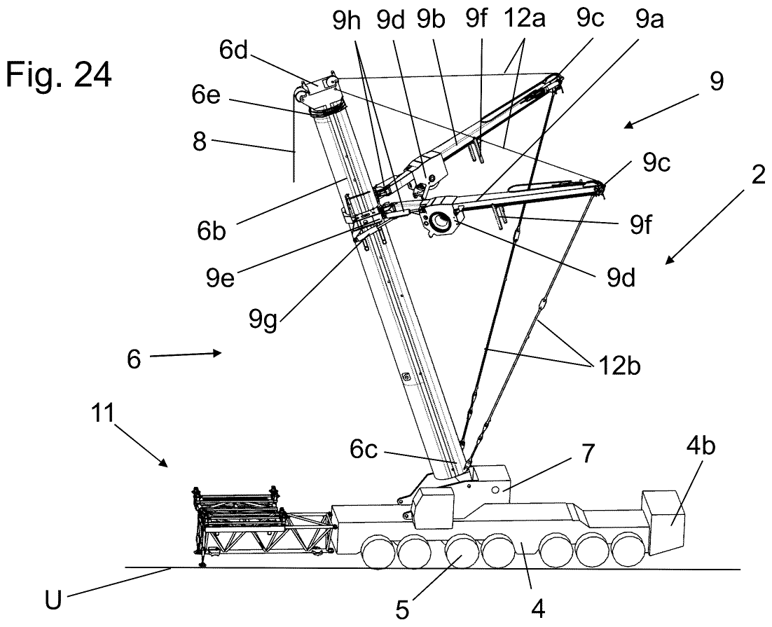

A bracing apparatus 9 for the telescoping jib 6 is transported on the loading surface 3c of the second transport unit 3b as an attachment for the vehicle crane 2. Such bracing apparatuses 9 are known for achieving an increase in the load-bearing capacity of the vehicle crane 2, provide rear and lateral bracing of the telescoping jib 6 and reduce elastic sagging of the telescoping jib 6 during operation of the vehicle crane 2. For this purpose, the bracing apparatus 9 is typically attached to the basic box 6a of the telescoping jib 6 and, in one embodiment variant, in the region of its upper collar 6e. The bracing apparatus 9 consists of a first bracing arm 9a and a second bracing arm 9b which are coupled to the telescoping jib 6 and can be splayed rearwards and in a v-shape to an operating position. It is also evident that the first and second bracing arms 9a, 9b each have, in a central and lower region, a tensioning mechanism 9d in the form of a cable winch in order to tension tensioning means such as bracing cables 12a and bracing rods 12b (see FIG. 24) of associated bracing in an appropriate manner. On the second transport unit 3b, the two bracing arms 9a, 9b are in a horizontal, mutually parallel and spaced-apart transport position. In the transport position, the two bracing arms 9a, 9b are oriented with their longitudinal directions substantially in parallel with a longitudinal direction of the second transport unit 3b. Moreover, the two bracing arms 9a, 9b are placed as closely as possible to one another on the loading surface 3c such that they preferably do not protrude laterally beyond the loading surface. In a mounting position of the two bracing arms 9a, 9b on the telescoping jib 6, the two bracing arms 9a, 9b are arranged in an operating position next to one another, wherein the distance between the two bracing arms 9a, 9b is greater than in the transport position and is adapted to the width of the telescoping jib 6. The two bracing arms 9a, 9b are placed on the loading surface 3c in a common transport framework 10, adapted to the geometry of the two bracing arms 9a, 9b, and are secured at this location for transport purposes.

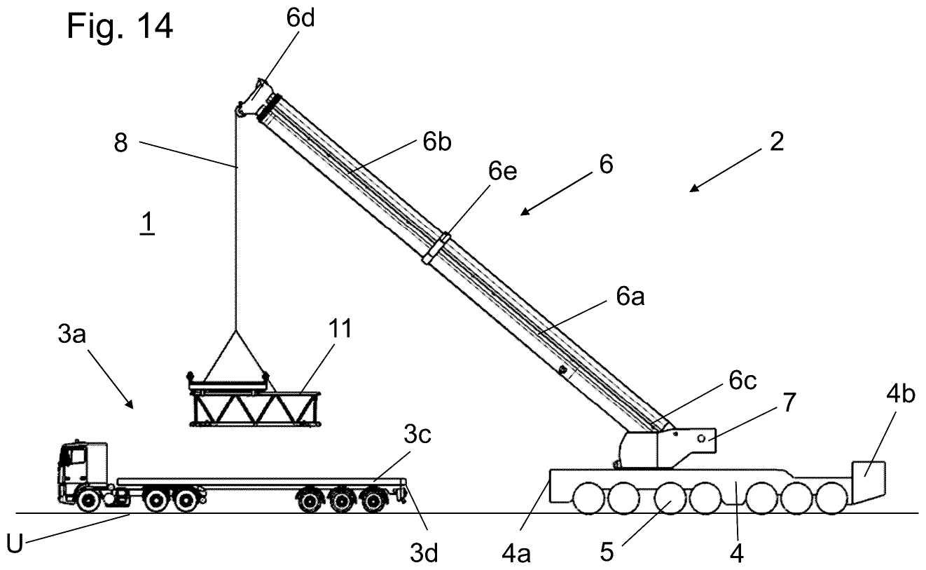

FIG. 14 illustrates a further schematic view of the vehicle crane 2 and the first transport unit 3a shown in FIG. 13. At the beginning of a so-called rigging procedure for attaching the first bracing arm 9a and the second bracing arm 9b to the telescoping jib 6, the first transport unit 3a is oriented with respect to the vehicle crane 2 in such a way that the first transport unit 3a is located with its longitudinal direction in extension of the vehicle crane 2 in relation to its longitudinal direction. In this case, a distance remains between the vehicle crane 2 and the first transport unit 3a. Moreover, in this case a rear end 4a of the lower carriage 4, which is opposite to a driver's cabin 4b of the vehicle crane 2, and a rear end 3d of the second transport unit 3b face one another, so that the loading surface 3c of the first transport unit 3a faces the vehicle crane 2. Alternatively, the vehicle crane 2 can be oriented in a corresponding manner with respect to the first transport unit 3a. In a next rigging step, after orientation the mounting framework 11 is raised from the loading surface 3c by means of the vehicle crane 2 so that the first transport unit 3a can drive away.

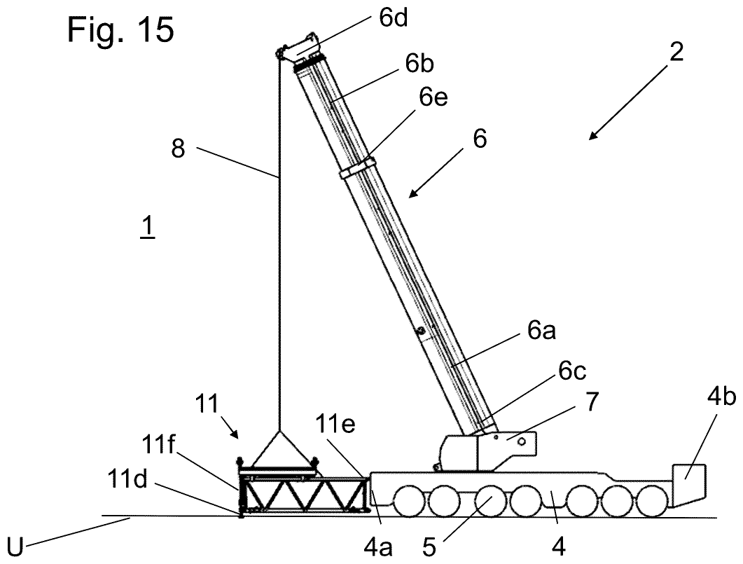

In a next step, as shown in FIG. 15, which shows a schematic view of the vehicle crane 2 shown in FIG. 14 with an attached mounting framework 11, it is evident that the mounting framework 11 has been moved into a fastening position onto the rear end 4a of the lower carriage 4 by means of the vehicle crane 2. In this coupling position, the front end 11e of the mounting framework 11 abuts against the rear end 4a of the lower carriage 4. The mounting framework 11 has also been lowered so far by the vehicle crane 2 that a top side of the mounting framework 11 is approximately at a common level with a surface of the lower carriage 4, and thus a receiving surface for the two bracing arms 9a, 9b on the lower carriage 4 has been extended with the mounting framework 11. In this coupling position, the mounting framework 11 is then fastened, in particular bolted, to the lower carriage 4. Support legs 11d which can be varied in length are also arranged at the opposite, rear end 11f of the mounting framework 11 in order to support the free rear end 11f of the mounting framework 11 on the ground surface U. Subsequently, the vehicle crane 2 or its lifting cable 8 is detached from the mounting framework 11 and is available for the further mounting steps.

FIG. 16 shows a perspective detailed view of the mounting framework 11 shown in FIG. 15 which is already fastened to the lower carriage 4 of the vehicle crane 2. In contrast to FIG. 15, in a further rigging step the lifting cable 8 has been detached from the mounting framework 11. The structure of the mounting framework 11 will be explained in greater detail hereinafter by reference to FIG. 16. The mounting framework 11 consists substantially of a lower base frame 11a, a central intermediate frame 11b, only one upper sliding frame 11c and support legs 11d. The base frame 11a has a latticework or frame structure and can have a triangular, quadrangular or polygonal cross-section. A lattice mast portion of a telescoping jib extension having a triangular cross-section can also be used. The base frame 11a has substantially the form of a cuboid or a three-sided prism. The base frame 11a also has a longitudinal direction G which, in the coupling position of the mounting framework 11, is oriented in extension with respect to a longitudinal direction L of the lower carriage 4. The longitudinal direction G is thus indicated centrally in relation to the symmetrical base frame 11a in FIG. 16 such that it also corresponds to a center line GM of the mounting framework 11. The length of the base frame 11a is selected such that the first and second bracing arms 9a, 9b can be placed on the mounting framework 11 one after the other in terms of time such that the vehicle crane 2 with its lowered telescoping jib 6, in particular with its basic box 6a, can move next to the bracing arms 9a, 9b which are to be picked up in each case. An intermediate frame 11b is fastened, preferably clamped or screwed, to the base frame 11a in detachable manner and, after fastening, is fastened thereto in a positionally fixed manner, said intermediate frame carrying a sliding frame 11c with two support elements 11ha, which are spaced apart from one another in the longitudinal direction G, for one of the two bracing arms 9a, 9b. The intermediate frame 11b and the sliding frame 11c are structural unit which can be fastened to respectively suitable base frames 11a. The leg-like support elements 11ha are in each case spaced apart from one other in the longitudinal direction G and are designed such that one of the two bracing arms 9a, 9b can be securely placed thereon. The sliding frame 11c can be displaced horizontally, linearly, in a mounting direction M and a first direction R1 and relative to the intermediate frame 11b in order to be able to orient or space apart the bracing arm 9a, 9b, which is received thereby, in a lateral manner with respect to the receiving telescoping jib 6. The sliding frame 11c is thus designed as an individual frame having only a single first storage location A1 for the first bracing arm 9a or for the second bracing arm 9b—in each case one after the other in terms of time. In relation to the base frame 11a, the sliding frame 11c can be moved by means of the intermediate frame 11b from a preferably completely retracted receiving position to a laterally, preferably completely extended lowering position and a central fastening position. For this purpose, a hydraulic cylinder 11g is arranged between the base frame 11a and the sliding frame 11c. It is obvious that the hydraulic cylinder 11g can be replaced by any other suitable drive. In this fastening position, starting from the receiving position, the sliding frame 11c can be displaced exclusively only to the right in relation to the intermediate frame 11b and as seen in the direction of the vehicle crane 2. This means that only the right, first bracing arm 9a can be displaced from the sliding frame 11c with the intermediate frame 11b in this right fastening position on the base frame 11a to the lowering and fastening positions, required for mounting, on the right side of the basic box 6a. In the inner receiving position, one of the two bracing arms 9a, 9b, in the present case the right and first bracing arm 9a, is placed onto the mounting framework 11 by the vehicle crane 2. In the lowering position, the bracing arm 9a, 9b to be mounted is moved laterally outwards or to the right on the outside to such an extent that the telescoping jib 6 can be lowered next to or at the height of the bracing arm 9a, 9b without colliding with the respective bracing arm 9a, 9b. From the lowering position, the bracing arm 9a, 9b can then be displaced in the direction of the telescoping jib 6 to the fastening position, so that the bracing arm 9a, 9b abuts against the basic box 6a and can be fastened at that location.

In addition, it is evident in FIG. 16 that a pair of support legs 11d which can be varied in length in the vertical direction are arranged at the rear end 11f. The two support legs 11d are opposite one another and spaced apart from one another in relation to the longitudinal direction G. The two support legs 11d together with an allocated holding frame 11i also form a structural unit which can be fastened to respectively suitable base frames 11a. The support legs 11d can also be an integral part of the mounting framework 11.

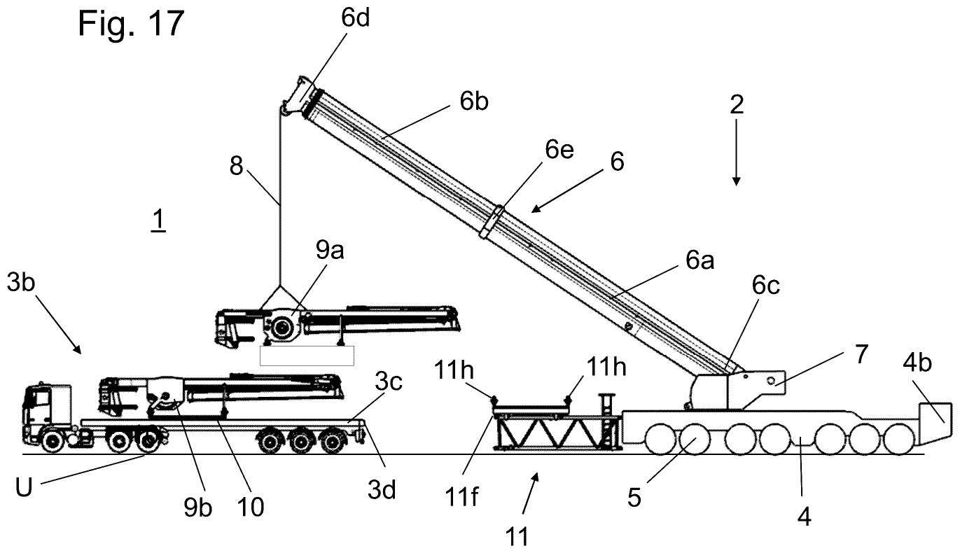

After the mounting framework 11 has been fastened to the lower carriage 4, one of the two bracing arms 9a, 9b is transported thereto in a next rigging step. For this purpose, it is apparent from FIG. 17, which shows a schematic view of the vehicle crane 2 and the second transport unit 3b shown in FIG. 13 with a raised first bracing arm 9a, that the second transport unit 3b is initially oriented with respect to the vehicle crane 2 in such a way that the second transport unit 3b is positioned with its longitudinal direction in extension of the vehicle crane 2 in relation to its longitudinal direction. As described above in respect of FIG. 14, in this case a distance remains between the vehicle crane 2 and the second transport unit 3b. Moreover, in this case the rear end 11f of the mounting framework 11 and the rear end 3d of the second transport unit 3b face one another such that the loading surface 3c of the second transport unit 3b faces the vehicle crane 2. Alternatively, the vehicle crane 2 can be oriented in a corresponding manner with respect to the second transport unit 3b. After the orientation, in a next rigging step only the first bracing arm 9a of the two bracing arms 9a, 9b is raised from the second transport unit 3b by means of the vehicle crane 2. The first bracing arm 9a is raised in a typical manner by winding up the lifting cable 8, by luffing up the telescoping jib 6 or extending an inner box 6b, as well as combinations thereof. Prior to the raising, the lifting cable 8 has typically been connected to the first bracing arm 9a. In this case, the transport framework 10 remains on the loading surface 3c of the first transport surface 3a in precisely the same way as the second bracing arm 9b. Subsequently, the second bracing arm 9b is mounted in a comparable manner after the first bracing arm 9a has been fastened to the telescoping jib 6.

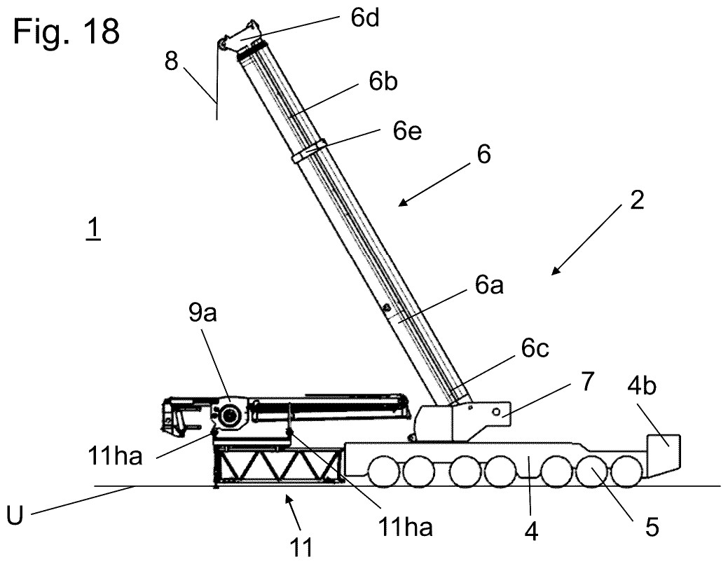

FIG. 18 illustrates a schematic view of the vehicle crane 2 shown in FIG. 17 in a subsequent rigging state. It is evident that the first bracing arm 9a previously received has been placed onto the mounting framework 11, in particular onto the two support elements 11ha present at that location. The lifting cable 8 has then been detached from the first bracing arm 9a. In the present case, legs 9f are provided on the first bracing arm 9a in order to facilitate or permit placement on the mounting framework 11. The first bracing arm 9a is thus supported on the support elements 11ha via the legs 9f. Fundamentally, it is feasible that no legs and only reinforcements or guide surfaces are provided on the bracing arms 9a, 9b and they cooperate directly with the support elements 11ha when they are being placed into position. The vehicle crane 2 is now available for the further mounting step, in particular the fastening of the first bracing arm 9a to the basic box 6a.

FIG. 19 illustrates a perspective detailed view of the mounting framework 11 with a received first bracing arm 9a shown in FIG. 16. The first bracing arm 9a has already been moved from its inner/central or left receiving position, in which the sliding frame 11c is located above the base frame 11a, to its right lowering position which is extended preferably completely along the intermediate frame 11b. If the first bracing arm 9a is located in this lateral lowering position, the telescoping jib 6 can be lowered to its substantially horizontal receiving position such that the basic box 6a is oriented on a level with a fastening frame 9e of the first bracing arm 9a. The first bracing arm 9a in the lowering position does not hinder the basic box 6a from being lowered to its receiving position. There is sufficient free space, at least 100 mm and at most 1000 mm, preferably 400 mm to 800 mm, available between the basic box 6a and the first bracing arm 9a for lowering purposes.

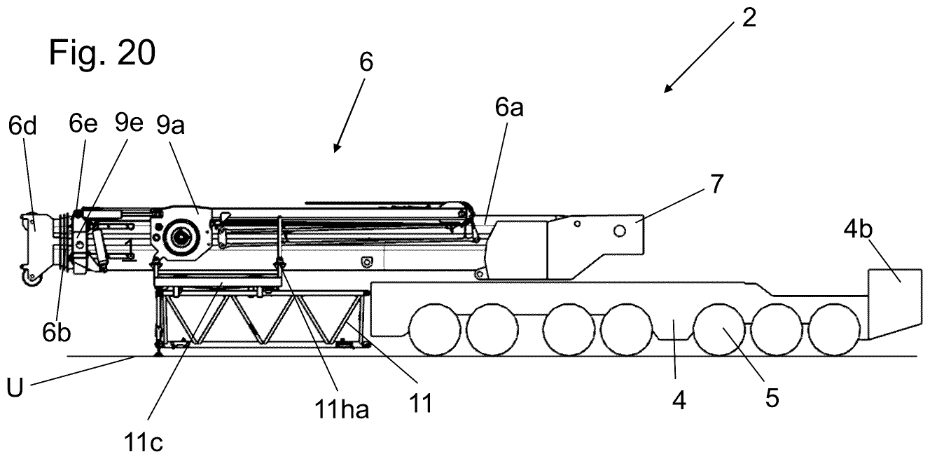

FIG. 20 shows a schematic side view of the vehicle crane 2 with its telescoping jib 6 lowered to the horizontal receiving position. It is evident that the first bracing arm 9a extends substantially in parallel with the telescoping jib 6 and the fastening frame 9e is arranged, as seen in the side view, in front of the collar 6e of the basic box 6a. FIG. 20 and also FIG. 19 show also that the inner boxes 6b have been retracted for the purpose of lowering the telescoping jib 6.

After lowering the telescoping jib 6, the sliding frame 11c is displaced from its lowering position together with the first bracing arm 9a inwards onto the basic box 6a and so the fastening frame 9e comes to abut against the collar 6e of the basic box 6a. The sliding frame 11c is then located with the first bracing arm 9a in the central fastening position.

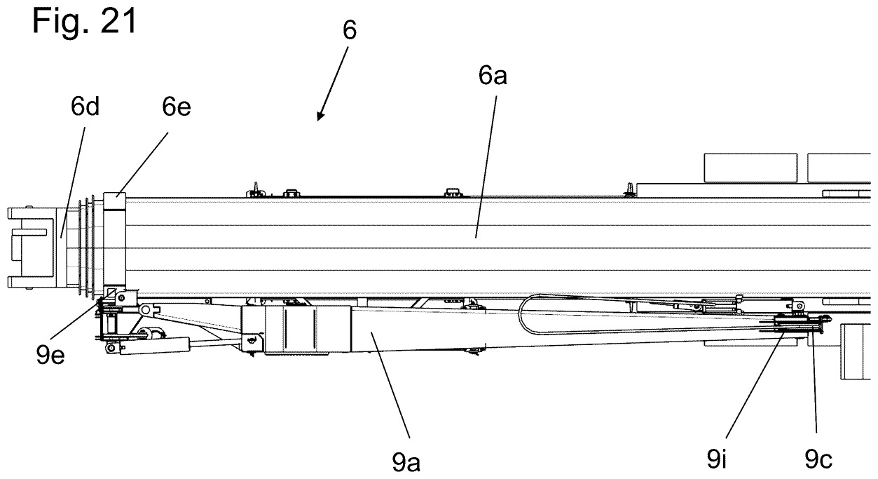

In FIG. 21 which shows an enlarged section of a plan view of the first bracing arm 9a shown in FIG. 20, the first bracing arm 9a abuts with its fastening frame 9e laterally against the collar 6e of the basic box 6a of the telescoping jib 6. Now, the first bracing arm 9a is fastened, in particular bolted, to the basic box 6a. The first bracing arm 9a is then picked up from the mounting framework 11 by luffing up the telescoping jib 6 and the vehicle crane 2 is ready for mounting the second bracing arm 9b. The first bracing arm 9a remains in an applied attachment position which extends substantially in parallel with the telescoping jib 6.

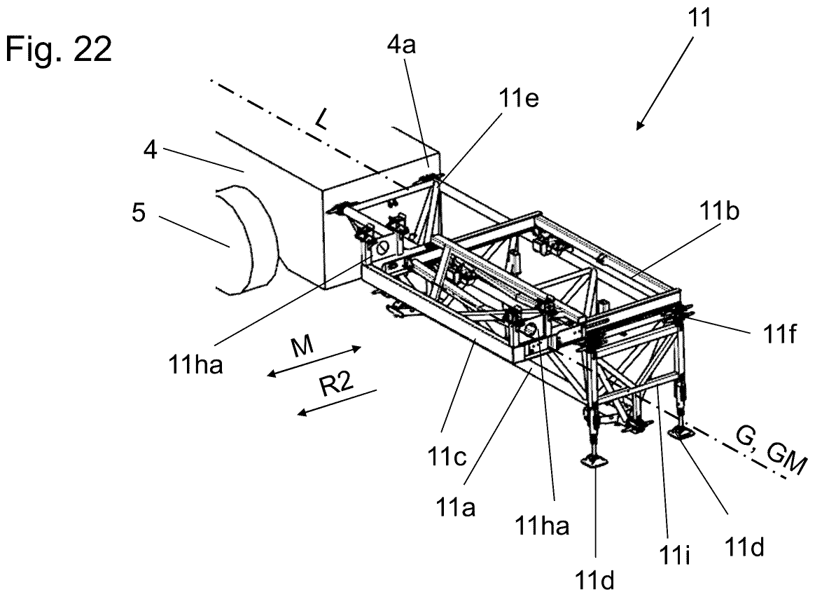

FIG. 22 shows a further perspective detailed view of the mounting framework 11 on the vehicle crane 2 shown in FIG. 16. However, in contrast to the view in FIG. 16, the structural unit consisting of the intermediate frame 11b and sliding frame 11c—when rotated through 180 degrees about an imaginary vertical axis—has been fastened or screwed to the base frame 11a. For this purpose, the intermediate frame 11b and the hydraulic cylinder 11g have previously been detached from the base frame 11a, raised with the vehicle crane 2, rotated through 180 degrees, then placed on the base frame 11a and fastened at that location. In a corresponding manner, the sliding frame 11c can now be displaced from its receiving position above the base frame 11a to the left to its laterally extended lowering position. FIG. 22 illustrates the sliding frame 11c in the lowering position.

After the intermediate frame 11b has been rotated together with the sliding frame 11c, the second bracing arm 9b can additionally be attached to the telescoping jib next to the first bracing arm 9a, as previously described in detail in relation to the first bracing arm 9a in conjunction with FIGS. 17 to 21.

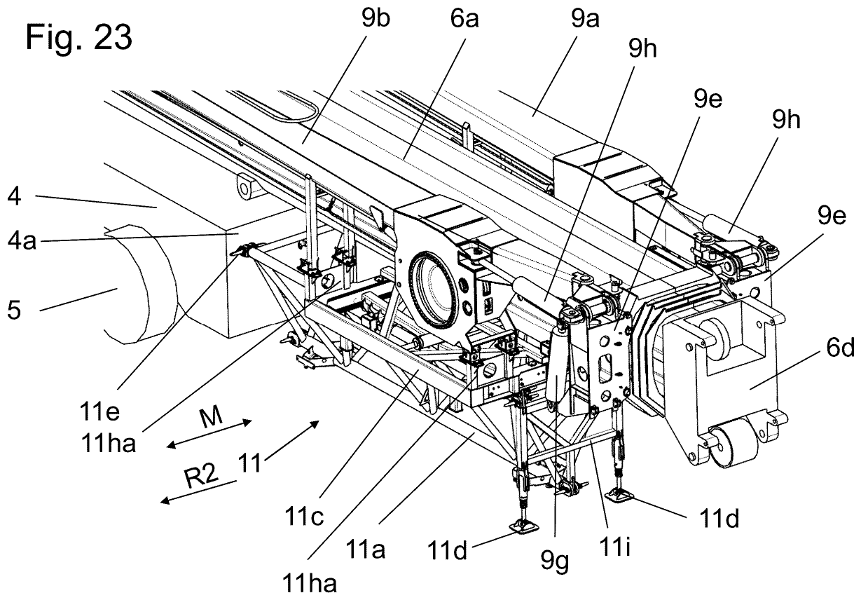

FIG. 23 illustrates a perspective detailed view of the mounting framework 11 with a first bracing arm 9a and a second bracing arm 9b shown in FIG. 19. The first bracing arm 9a has already been fastened to the basic box 6a as described previously. The second bracing arm 9b has also been placed previously on the second support elements 11ha by the vehicle crane 2. In this case, the sliding frame 11c was in its retracted receiving position. Subsequently, the sliding frame 11c has been extended to the left together with the second bracing arm 9b to its left lowering position. Then, the telescoping jib 6 together with the already mounted first bracing arm 9a is luffed down to its substantially horizontal receiving position next to the second bracing arm 9b. In a further step, the sliding frame 11c is moved with the second bracing arm 9b from its lowering position inwards to its central fastening position, in which the fastening frame 9e of the second bracing arm 9b abuts against the collar 6e of the basic box 6a. Subsequently, the fastening frame 9e of the second bracing arm 9b is fastened, in particular bolted, to the collar 6e of the basic box 6a. This means that the first bracing arm 9a and the second bracing arm 9b have now been fastened to the basic box 6a one after the other in terms of time.

FIG. 24 shows a schematic and perspective view of the vehicle crane 2 with its bracing apparatus 9 with the two attached bracing arms 9a, 9b in the operating state. After the two bracing arms 9a, 9b have been attached to the telescoping jib 6 as described above, the bracing arms 9a, 9b are erected and braced in a known manner. For this purpose, in a first step, bracing cables 12a are each guided from the tensioning mechanism 9d via a deflection roller 9i arranged on a tip 9c of the respective bracing arm 9a, 9b (see FIG. 21) to the telescoping jib head 6d where they are fastened. Then, in a further step a plurality of bracing rods 12b arranged one behind the other are arranged between the telescoping jib foot 6c and the tip 9c of the respective bracing arm 9a, 9b. Instead of bracing rods 12, cables or chains or combinations thereof can also be used. The tensioning mechanism 9d is arranged below each of the bracing arms 9a, 9b and, starting from the center of the longitudinal extension of the bracing arms 9a, 9b, in a manner offset in the direction of the fastening frame 9e. As previously described, the fastening frame 9e serves to fasten the bracing arm 9a, 9b to the basic box 6a. The fastening frame 9e also comprises a double joint in order to erect the respective bracing arm 9a, 9b relative to the basic box 6a by means of an erecting cylinder 9g, arranged between the fastening frame 9e and the bracing arm 9a, 9b, and in order to be able to pivot said bracing arm laterally to the V-position by means of a pivoting cylinder 9h arranged between the fastening frame 9e and the bracing arm 9a, 9b. Subsequently, the telescoping jib 6 is luffed up together with the two bracing arms 9a, 9b. The two bracing arms 9a, 9b are then set up from their transport position almost in parallel with the telescoping jib 6 by means of the erecting cylinders 9g relative to the telescoping jib 6 and the two bracing arms 9a, 9b are splayed in a v-shape by means of the pivoting cylinders 9h. The two bracing arms 9a, 9b are thus oriented approximately orthogonally to the basic box 6a and form an angle of about 60 degrees with respect to one another. The bracing rods 12b are tensioned by the actions of erecting and pivoting-out. The bracing cables 12 are tensioned in parallel via the tensioning mechanisms 9d. Where required, the inner boxes 6b can be extended and the bracing cables 12a can be adjusted and tensioned via the tensioning mechanisms 9d. The bracing cables 12a or bracing rods 12b can also be connected to an additional counterweight. Such bracing apparatuses 9 can also be referred to as a Sideways Superlift SSL.

In a step concluding the rigging procedure, the lifting cable 8 is then attached to the mounting framework 11, the mounting framework 11 is detached from the lower carriage 4 and temporarily stored by the vehicle crane 2 at a suitable location or on the second transport unit 3b for subsequent dismounting of the two bracing arms 9a, 9b.

The bracing apparatus 9 is dismounted from the telescoping jib 6 in the reverse sequence.

In each of the previous exemplified embodiments, a transport frame 10 has been described, on which the first and second bracing arms 9a, 9b are placed together for transport on the second transport unit 3b. Preferably, the transport framework 10 is designed in one piece for both bracing arms 9a, 9b and thus determines the distance between the two bracing arms 9a, 9b in the transport position on the second transport unit 3b. This transport framework 10 also remains on the second transport unit 3b when the two bracing arms 9a, 9b are transported to the vehicle crane 2 as part of the rigging procedure. It is also feasible to separate the transport framework 10 into a first part for the first bracing arm 9a and a second part for the second bracing arm 9b. It is then possible either to leave the first part and also the second part of the transport framework 10 on the second transport unit 3b or to transport them together with the first and second bracing arms 9a, 9b to the mounting framework 11. In the latter case, the first part and also the second part of the transport framework 10 are then separated from the first and second bracing arms 9a, 9b respectively during the course of further rigging, and remain on the mounting framework 11 until it is required for the return transport of the two bracing arms 9a, 9b to the second transport unit 3b. The sliding frame 11c of the mounting framework 11 has correspondingly complementary support elements 11ha, 11hb for receiving the first part and also the second part of the transport framework 10. These support elements 11ha, 11hb are leg-like for receiving the first and second bracing arms 9a, 9b respectively and are flat for receiving the respective part of the transport framework 10.

In connection with the previous exemplified embodiments, the base frame 11a has been described as a lattice mast structure and also as a lattice mast portion of a telescoping jib extension with a triangular cross-section. However, the base frame 11a can have any type of lattice work, box or frame structure and can have a triangular, quadrangular or polygonal cross-section. The base frame 11a, the support legs 11d and the holding frame 11i can also be combined to form a welded, connected or screwed component. In relation to the exemplified embodiment shown in FIGS. 1 to 12, the sliding frame 11c can also be fixedly welded, connected or screwed to the base frame 11a.

Changes and modifications in the specifically described embodiments can be carried out without departing from the principles of the present invention which is intended to be limited only by the scope of the appended claims, as interpreted according to the principles of patent law including the doctrine of equivalents. The priority German application no. DE 10 2023 119 815.7, filed on Jul. 26, 2023, is hereby incorporated by reference, in particular for support with regard to the translation for the present disclosure.

1. A mounting framework of a vehicle crane, wherein at least one bracing arm of a bracing apparatus of the vehicle crane can be temporarily stored on the mounting framework, wherein the mounting framework comprises:
precisely one displaceable sliding frame, wherein a single bracing arm can be temporarily stored on the sliding frame.

2. The mounting framework as claimed in claim 1, wherein, starting from a receiving position, the sliding frame can be displaced either in a first direction or in a second direction opposite to the first direction and can be displaced back again.

3. The mounting framework as claimed in claim 1, wherein the sliding frame can be displaced in a mounting direction and can be displaced back again, and wherein the mounting direction extends orthogonally to a longitudinal direction of the mounting framework.

4. The mounting framework as claimed in claim 1, wherein the mounting framework comprises a base frame, an intermediate frame and the sliding frame, and wherein the intermediate frame is arranged on the base frame and the sliding frame is arranged in a displaceable manner on the intermediate frame.

5. The mounting framework as claimed in claim 4, wherein the intermediate frame and the sliding frame form a structural unit and can be jointly detached from the base frame and, after a rotation, can then be fastened to the base frame such that, starting from a fully retracted receiving position, the sliding frame can be displaced only in a second direction opposite to the first direction and can be displaced back again.

6. The mounting framework as claimed in claim 5, wherein only one single storage location for the first bracing arm or the second bracing arm is arranged on the sliding frame.

7. The mounting framework as claimed in claim 1, wherein a first storage location for the first bracing arm and a second storage location for the second bracing arm are arranged on the sliding frame.

8. The mounting framework as claimed in claim 7, wherein first support elements are arranged on the sliding frame at the first storage location, and second support elements are arranged on the sliding frame at the second storage location.

9. The mounting framework as claimed in claim 3, wherein the mounting framework comprises a base frame, an intermediate frame and the sliding frame, and wherein the intermediate frame is arranged on the base frame and the sliding frame is arranged in a displaceable manner on the intermediate frame.

10. The mounting framework as claimed in claim 9, wherein the intermediate frame and the sliding frame form a structural unit and can be jointly detached from the base frame and, after a rotation, can then be fastened to the base frame such that, starting from a fully retracted receiving position, the sliding frame can be displaced only in a second direction opposite to the first direction and can be displaced back again.

11. The mounting framework as claimed in claim 10, wherein only one single storage location for the first bracing arm or the second bracing arm is arranged on the sliding frame.

12. The mounting framework as claimed in claim 11, wherein a first storage location for the first bracing arm and a second storage location for the second bracing arm are arranged on the sliding frame.

13. The mounting framework as claimed in claim 12, wherein first support elements are arranged on the sliding frame at the first storage location, and second support elements are arranged on the sliding frame at the second storage location.

14. A vehicle crane comprising a mounting framework as claimed in claim 1, wherein the vehicle crane comprises a lower carriage and wherein the mounting framework is fastened to the lower carriage in extension of the lower carriage.

15. The vehicle crane as claimed in claim 14, wherein the mounting framework is supported on a ground surface via support legs at a rear end remote from the lower carriage.

16. The vehicle crane as claimed in claim 14, wherein the vehicle crane further comprises a superstructure and a telescoping jib, wherein the telescoping jib comprises a basic box with retractable and extendible inner boxes, and wherein the bracing apparatus having the first bracing arm and the second bracing arm can be attached to the telescoping jib and, for attachment purposes, the first bracing arm and the second bracing arm can be placed on the mounting framework one after the other.

17. A method for mounting a bracing apparatus on a telescoping jib of a vehicle crane, comprising:
providing a first transport unit having a mounting framework, received thereon, in the region of the vehicle crane;
raising the mounting framework from the first transport unit via the vehicle crane;
positioning the mounting framework in extension of a lower carriage of the vehicle crane;
fastening the mounting framework to the lower carriage and detaching the vehicle crane from the mounting framework;
providing a second transport unit having a bracing apparatus, which is received thereon and includes a first bracing arm and a second bracing arm, in the region of the vehicle crane;
raising the first bracing arm from the second transport unit by means of the vehicle crane;
lowering the first bracing arm of the bracing apparatus onto a sliding frame of the mounting framework at a first storage location via the vehicle crane;
displacing the sliding frame in a first direction from a receiving position to a laterally extended lowering position;
luffing the telescoping jib down next to the first bracing arm;
displacing the sliding frame in the mounting direction and in the direction opposite to the first direction from its lowering position to a central fastening position, in which a fastening frame of the telescoping jib abuts against a basic box of the telescoping jib;
fastening the first bracing arm with its fastening frame to the basic box;
repeating the aforementioned steps in relation to the second bracing arm beginning with raising the first bracing arm from the second transport unit via the vehicle crane and in relation to a second storage location on the sliding frame and a second direction.

18. A method for mounting a bracing apparatus on a telescoping jib of a vehicle crane, comprising:
providing a first transport unit having a mounting framework, received thereon, in the region of the vehicle crane;
raising the mounting framework from the first transport unit via the vehicle crane;
positioning the mounting framework in extension of a lower carriage of the vehicle crane;
fastening the mounting framework to the lower carriage and detaching the vehicle crane from the mounting framework;
providing a second transport unit having the bracing apparatus, which is received thereon and includes a first bracing arm and a second bracing arm, in the region of the vehicle crane;
raising the first bracing arm from the second transport unit by means of the vehicle crane;
lowering the first bracing arm of the bracing apparatus onto a sliding frame of the mounting framework by means of the vehicle crane;
displacing the sliding frame in a first direction from a receiving position to a laterally extended lowering position;
luffing the telescoping jib down next to the first bracing arm;
displacing the sliding frame in the mounting direction and in the direction opposite to the first direction from its lowering position to a central fastening position, in which a fastening frame of the telescoping jib abuts against a basic box of the telescoping jib;
fastening the first bracing arm with its fastening frame to the basic box;
detaching the intermediate frame and the sliding frame jointly as a structural unit from the base frame, rotating the structural unit and fastening it to the base frame such that, starting from a fully retracted receiving position, the sliding frame can be displaced only in a second direction opposite to the first direction and can be displaced back again;
repeating the aforementioned steps in relation to the second bracing arm beginning with raising the first bracing arm from the second transport unit via the vehicle crane on the sliding frame and a second direction.
